(19) United States
(12) Patent Application Publication
(10) Pub. No.: US 2021/0224415 A1
(43) Pub. Date: Jul. 22, 2021

(54) Privacy Protection Through Template Embedding

(71) Applicant: International Business Machines Corporation, Armonk, NY (US)

(72) Inventors: Haode Qi, Cambridge, MA (US); Saloni Potdar, Arlington, MA (US); Ming Tan, Malden, MA (US); Navneet R. Rao, Arlington, MA (US)

(21) Appl. No.: 16/749,163

(22) Filed: Jan. 22, 2020

(51) Int. Cl. G06F 21/62; G06K 9/34; G06F 40/186; G06K 9/48; G06F 40/279

(52) U.S. Cl. CPC G06F 21/6245; G06K 9/344; G06K 2209/01; G06K 9/481; G06F 40/279; G06F 40/186

(57) ABSTRACT

A mechanism is provided to implement a personally identifiable information (PII) detection mechanism that facilitates privacy protection utilizing template embedding learned from text sequences. Input text is processed using natural language processing to identify one or more pieces of personally identifiable information. A character analysis is performed of each character of each piece of personally identifiable information of the one or more pieces of personally identifiable information to identify a character type of character in the piece of personally identifiable information. For each piece of personally identifiable information and based on the associated identified character type, the identified character type is mapped to an associated template character in a set of template characters in a template character data structure. Utilizing the character-to-template mappings for the one or more pieces of personally identifiable information, an output text is generated that projects the template characters by direct character-level mapping.

### BACKGROUND

The present application relates generally to an improved data processing apparatus and method and more specifically to mechanisms for providing privacy protection utilizing template embedding learned from text sequences.

Personally identifiable information (PII) is any data that could potentially be used to identify a particular person. Examples of PII include a full name, Social Security number, driver's license number, bank account number, passport number, and email address. PII is often discussed in the context of data breaches and identity theft. If a company or organization suffers a data breach, a significant concern is what might be exposed the personal data of the customers that do business or otherwise interact with the entity.

Not all PII is equal in terms of importance or sensitivity. For instance, a Social Security number is associated with only one person. That makes a Social Security number critically important to that person's identity. On the other hand, it's possible—even likely in some cases—that many people may have the same name, such as Steve Smith or Maria Garcia. So, while a person's name is an important piece of PII, a person's name is secondary a person's Social Security number.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, comprising at least one processor and at least one memory is provided, where the at least one memory comprises instructions that are executed by the at least one processor to implement a personally identifiable information (PII) detection mechanism that facilitates privacy protection utilizing template embedding learned from text sequences. The illustrative embodiment processes the input text using natural language processing to identify one or more pieces of personally identifiable information in response to receiving the input text. The illustrative embodiment performs a character analysis of each character of each piece of personally identifiable information of the one or more pieces of personally identifiable information to identify a character type of character in the piece of personally identifiable information. For each piece of personally identifiable information and based on the associated identified character type, the illustrative embodiment maps the identified character type to an associated template character in a set of template characters in a template character data structure. Utilizing the character-to-template mappings for the one or more pieces of personally identifiable information, the illustrative embodiment generates an output text that projects the template characters by direct character-level mapping.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a functional block diagram of a personally identifiable information (PII) detection mechanism implementing privacy protection utilizing template embedding in accordance with an illustrative embodiment;

FIG. 4 provides an example of the process performed by the personally identifiable information (PII) detection mechanism described in FIG. 3 in accordance with an illustrative embodiment; and

FIG. 5 depicts a flow diagram of the operation performed by personally identifiable information (PII) detection mechanism in protection the privacy of customer information utilizing template embedding in accordance with an illustrative embodiment.

### DETAILED DESCRIPTION

Again, personally identifiable information (PII) is any data that could potentially be used to identify a particular person. Examples if PII include a full name, Social Security number, driver's license number, bank account number, passport number, email address, or the like. Thus, if an enterprise who holds one or pieces of a customer's PII suffers a data breach, not only could the customer's PII be exposed, but, the leaking of such PII may put the enterprise at risk for litigation as well as putting the enterprises' reputation at risk. Thus, in order to protect not only the customer's PII but also the enterprises' good standing, the illustrative embodiments provide for an improvement to existing PII detection mechanisms.

That is, existing PII detection mechanisms utilize pattern matching or machine learning. In the pattern matching approach, the PII detection mechanisms utilize regular expression detection, which is a dictionary based approach. However, this pattern matching approach requires the generation of a tailored template for each particular type of PII, which is time consuming because the pattern matching may not be generalized. In the machine learning approach, the PII detection mechanisms utilize word/character sequence-to-sequence modeling. However, in PII mechanisms that use word sequence-to-sequence modeling, these PII detection mechanisms fail to capture character information and in PII detection mechanisms that use character sequence-to-sequence modeling, these PII detection mechanisms fail to be sensitive to different character inputs. In fact, these PII detection mechanisms are overly sensitive to the popular character inputs in the training data. For examples, if every single email in the training data follows the same format as xxx@ibm.com. When these systems see a website www.ibm.com, these systems will likely to confuse the website with an email. On the contrary, our system is sensitive only to key character inputs. In our case, instead of learning xxx@ibm.com, we will learn ccc@ccc.ccc instead, which will be a much better representation than the original input.

Therefore, the illustrative embodiments provide a PII detection mechanism that utilizes template embedding learned from text sequences. The PII detection mechanism implements a novel word-level pattern encoding mechanism to deal with PII detection in text sequences, which may then be used in combination with any existing or future PII detection mechanisms, such as character embeddings, word embeddings, and sequence-to-sequence models. In the illustrative embodiment, the PII detection mechanism creates a set of template characters in a template data structure. For example, “C” for capital letters, “c” for lowercase letters, “n” for numbers, special characters, such as “$,” “-,” “?,” or the like, as well as other template characters, which may be system or user defined. Given any input text sequence, the PII detection mechanism projects the template characters by direct character-level mapping. The PII detection mechanism then uses the generated template characters to generate an template encoding for each input PII word, and combines them utilizing word embeddings as inputs for sequence-to-sequence models. Utilizing the PII detection mechanism of the illustrative embodiment knowledge may be transferred to unseen privacy information formats. Additionally, the PII detection mechanism provides attention to important symbols and utilizes template information without explicitly defining the template structure. Further, the PII detection mechanism provides template embedding that is insensitive to the actual value of the input and allows the length of input tokens to be flexible. As such, the PII detection mechanism of the illustrative embodiments may be applied to, for example, algorithms that expose data to end user will need PII removal, algorithms that train on customer data or logs which unintentionally extract and store PII, as well as formally approved data releases, data transfers, or the like, across products in which PII exists and require PII removal.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

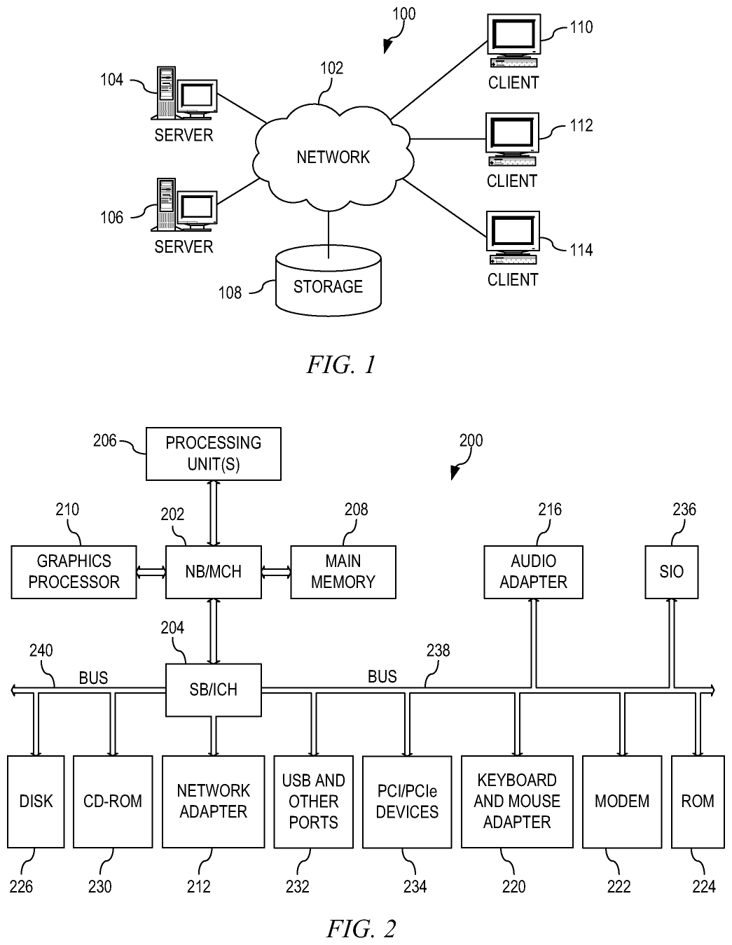

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages, Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104 may be specifically configured to implement a PII detection mechanism that provides privacy protection utilizing template embedding learned from text sequences. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, and software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates privacy protection utilizing template embedding learned from text sequences.

As noted above, the mechanisms of the illustrative embodiments utilize specifically configured computing devices, or data processing systems, to perform the operations for providing privacy protection utilizing template embedding learned from text sequences. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCII 202, Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 10®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 tor execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the PII detection mechanism of the illustrative embodiments.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may, be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

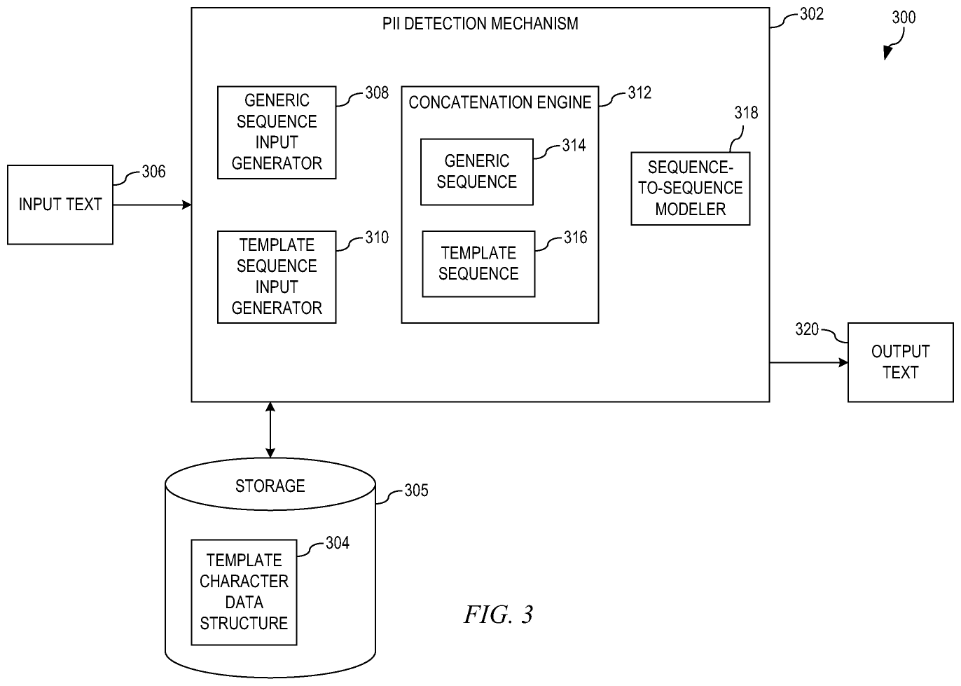

FIG. 3 depicts a functional block diagram of a personally identifiable information (PII) detection mechanism implementing privacy protection utilizing template embedding in accordance with an illustrative embodiment. Data processing system 300, which may be a data processing similar to that of data processing system 200 of FIG. 2, comprises PII detection mechanism 302 which is coupled to a template character data structure 304 in storage 305. Template character data structure 304 comprises a set of template characters for use in protecting the privacy of persons. For example, template character data structure 304 a template “C” for uppercase letters, a template “c” for lowercase letters, a template “n” for numbers, a template “m” for uncommon special characters such as “′”, “\hat{ }”, or the like, common special character templates, such as “$”, “-”, “?”, or the like, as well as other template characters that may be system or user defined. It should be noted that whether a special character is considered to be common or uncommon may be based on user preferences, special character usages statistics, or the like. That is, while some of the template characters are system defined, a user may be able to redefine the template character or add an additional template character.

In operation, PII detection mechanism 302 receives input text 306, which may be, for example, customer data, logs, data releases, data transfers, records, documents, or the like. A one example, text sequence may be a sentence, such as “The home address of John Smith is 750 Binney St., Cambridge, Mass. 02134.” Upon receiving input text 306, generic sequence input generator 308 within PII detection mechanism 302 processes input text 306 to identify one or more pieces of personally identifiable information, such as a full name, Social Security number, driver's license number, hank account number, passport number, email address, or the like, Natural language processing is a specific computer technique used to derive meaning from natural language content in data structures, such as input text 306. Thus, by processing input text 306, generic sequence input generator 308 may identify one or more pieces of input text 306 that are personally identifiable information. For example, generic sequence input generator 308 identifies “John Smith” as a full name and “750 Binney St., Cambridge, Mass. 02134” as an address.

Regardless of any length of the identified one or more pieces of input text 306 that are personally identifiable information, generic sequence input generator 308 performs a character analysis of each piece of the one or more pieces of personally identifiable information to identify one or more character types, such as uppercase characters, lowercase characters, numbers, special characters, or the like. Therefore, for the name “John Smith,” generic sequence input generator 308 identifies the following characters: uppercase character, lowercase character, lowercase character, lowercase character, white space, uppercase character, lowercase character, lowercase character, lowercase character, and lowercase character. Thus, generic sequence input generator 308 generates a set of vectors for each piece of the one or more pieces of personally identifiable information. In accordance with the example above, a first generic vector may be “John,” a second generic vector may be “Smith,” a third generic vector may be “750,” and so on.

In another process, upon receiving input text 306 and for each piece of the one or more pieces of personally identifiable information, template sequence input generator 310 utilizes the character analysis to map the identified character to a template character in the set of template characters in template character data structure 304. Thus, template sequence input generator 310 would generate template vectors such as: for the name “John”, template sequence input generator 310 would identify “Cccc”; for the name “Smith”, template sequence input generator 310 would identify “Ccccc”; for “750”, template sequence input generator 310 would identify “nnn”; for “Binney”, template sequence input generator 310 would identify “Cccccc”; for “St.,”, template sequence input generator 310 would identity “Cc.,”; for “Cambridge,”, template sequence input generator 310 would identify “Ccccccccc,”; for “MA”, template sequence input generator 310 would identify “CC”; and for “02134”, template sequence input generator 310 would identify “nnnnn”.

Utilizing the generic vectors generated by generic sequence input generator 308 and the template vectors generated by template sequence input generator 310, concatenation engine 312 concatenates the generic vectors with the template vectors into a set of sequences 314. In keeping with the example above, the set of vectors would be (“John”, “Cccc”), (“Smith”, “Ccccc”), (“750”, “nnn”), (“Binney”, “Cccccc”), (“St.”, “Cc.”), (“Cambridge”, “Ccccccccc”), (“MA”, “CC”), and (“02134”, “nnnnn”). Finally, using generic sequence 314, template sequence 316, and the reminder of input text 304 not identified as personally identifiable information, sequence-to-sequence modeler 318 generates output text 320, which in keeping with the example above would read as “The home address of Cccc Ccccc is nnn Cccccc Cc., Ccccccccc, CC nnnnn” Thus, PII detection mechanism 302 projects the template characters by direct character-level mapping. That is, PII detection mechanism 302 uses the set of template characters to generate a template encoding for each input PII word, and combines the encoded PII word to form a text sequence output that provides privacy protection for customer and enterprise protection.

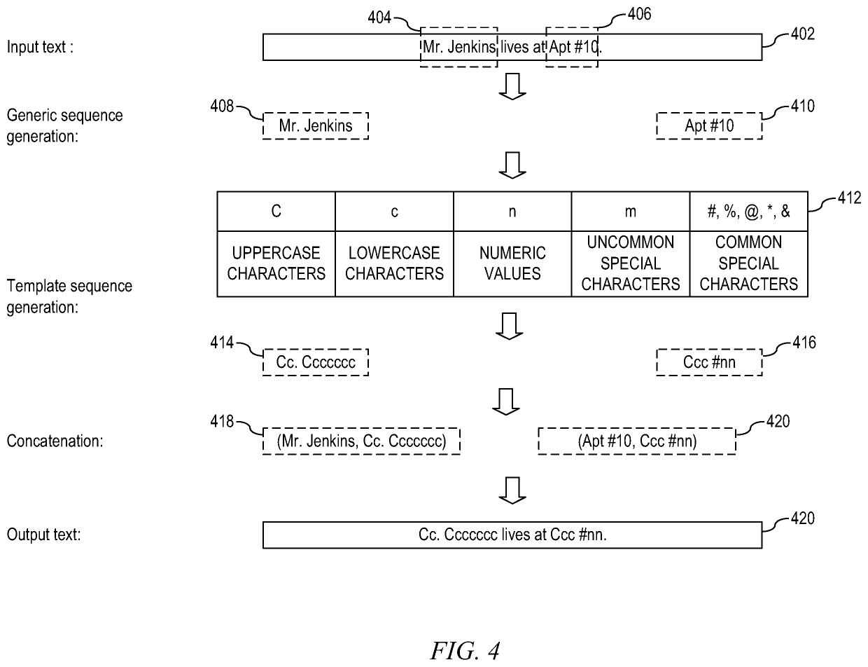

FIG. 4 provides an example of the process performed by the personally identifiable information (PII) detection mechanism described in FIG. 3 in accordance with an illustrative embodiment. As us shown in FIG. 4, input text 402 is received by the PII detection mechanism. Upon receiving input text 402, a generic sequence input generator within the PII detection mechanism uses natural language processing engine to process input text 402 to identify one or more pieces of personally identifiable information, such as name 404 and address 406. It is noted that in this example, name 404 and address 406 are each processed as a unit rather than by individual pieces. That is, for example, address 406 is processed as “Apt #10” rather than “Apt” and “#10”. The generic sequence input generator performs a character analysis of each piece of the one or more pieces of personally identifiable information to identify one or more character types, such as uppercase characters, lowercase characters, numbers, special characters, or the like thereby generating genetic vectors such as vectors 408 and 410. For each character identified by the character analysis engine, template sequence input generator of the PII detection mechanism maps the identified character to a template character in the set of template characters in template character data structure 412. Using the mapping, template sequence input generator generates template vectors 414 and 416.

Concatenation engine of the PII detection mechanism then concatenates the generic vector 408 and template vector 414 into sequence 418 and concatenates the generic vector 410 and template 416 into sequence 420. Using sequences 418 and 420 and the reminder of input text 402 not identified as personally identifiable information, sequence-to-sequence modeler 318 generates output text 422. Thus, the PII detection mechanism projects the template characters by direct character-level mapping. That is, the PII detection mechanism uses the set of template characters to generate a template encoding for each input PII word, and combines the encoded PII word to form a text sequence output that provides privacy protection for customer and enterprise protection.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly, on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

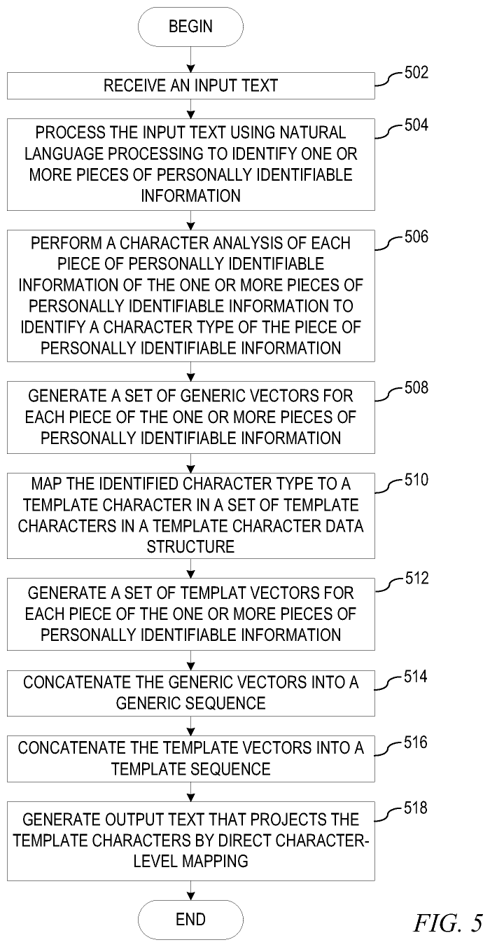

FIG. 5 depicts a flow diagram of the operation performed by personally identifiable information (PII) detection mechanism in protection the privacy of customer information utilizing template embedding in accordance with an illustrative embodiment. As the operation begins, the PII detection mechanism receives an input text (step 502). Responsive to receiving the input text, the PII detection mechanism processes the input, text using natural language processing to identify one or more pieces of personally identifiable information (step 504). The PII detection mechanism then performs a character analysis of each piece of personally identifiable information of the one or more pieces of personally identifiable information to identify a character type of the piece of personally identifiable information (step 506), such as uppercase characters, lowercase characters, numbers, special characters, or the like. For each piece of personally identifiable information, the PII detection mechanism generates a set of generic vectors for each piece of the one or more pieces of personally identifiable information (step 508).

For each piece of personally identifiable information and based on the associated identified character type, the PII detection mechanism maps the identified character type to a template character in a set of template characters in a template character data structure (step 510). For each piece of personally identifiable information and utilizing the character-to-template mappings for the one or more pieces of personally identifiable information, the PII detection mechanism generates a set of template vectors for each piece of the one or more pieces of personally identifiable information (step 512). The PII detection mechanism then concatenates the generic vectors into a generic sequence (step 514) and concatenates the template vectors into a template sequence (step 516). Utilizing the character-to-template mappings for the one or more pieces of personally identifiable information, the PII detection mechanism generates an output text that projects the template characters by direct character-level mapping (step 518), with the operation terminating thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for facilitating privacy protection utilizing template embedding learned from text sequences. The PII detection mechanism implements a novel word-level pattern encoding mechanism to deal with PII detection in text sequences, which may then be used in combination with any existing or future PII detection mechanisms, such as character embeddings, word embeddings, and sequence-to-sequence models. Given any input text sequence, the PII detection mechanism projects the template characters by direct character-level mapping. The PII detection mechanism then uses the generated template characters to generate an template encoding for each input PII word, and combines them utilizing word embeddings as inputs for sequence-to-sequence models.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for comprising at least one processor and at least one memory, wherein the at least one memory comprises instructions that are executed by the at least one processor to configure the at least one processor to implement a personally identifiable information (PII) detection mechanism that facilitates privacy protection utilizing template embedding learned from text sequences, the method comprising:
responsive to receiving the input text, processing the input text using natural language processing to identify one or more pieces of personally identifiable information;
performing a character analysis of each character of each piece of personally identifiable information of the one or more pieces of personally identifiable information to identify a character type of character in the piece of personally identifiable information;
for each piece of personally identifiable information and based on the associated identified character type, mapping the identified character type to an associated template character in a set of template characters in a template character data structure; and
utilizing the character-to-template mappings for the one or more pieces of personally identifiable information, generating an output text that projects the template characters by direct character-level mapping.

2. The method of claim 1, wherein performing the character analysis of each character of each piece of personally identifiable information of the one or more pieces of personally identifiable information to identify a character type of character in the piece of personally identifiable information further comprises:
for each piece of the one or more pieces of personally identifiable information, generating a generic vector for the one or more characters of the piece.

3. The method of claim 1, wherein mapping the identified character type to the associated template character in the set of template characters in a template character data structure further comprises:
for each piece of the one or more pieces of personally identifiable information, generating a template vector for the one or more template characters of the piece.

4. The method of claim 1, Wherein generating the output text that projects the template characters by direct character-level mapping further comprises:
for each piece of the one or more pieces of personally identifiable information, replacing a generic vector with a template vector while maintaining the remainder of the input text as received.

5. The method of claim 1, wherein the character type is selected from the group consisting of an uppercase character, a lowercase character, a number, an uncommon special character, or a common special character.

6. The method of claim 1, wherein the set of template characters comprises a defined template character for each character type identified in the set of template characters.

7. The method of claim 1, wherein a template character in the set of template characters may be either reassigned to another character by a user or newly assigned to a character by a user.

8. The method of claim 1, Wherein the input text is selected from the group consisting of customer data, logs, data releases, data transfers, records, or documents.

9. A computer program product comprising a computer readable storage medium having a computer readable program stored therein, wherein the computer readable program, when executed on a data processing system, causes the data processing system to implement a personally identifiable information (PII) detection mechanism that facilitates privacy protection utilizing template embedding learned from text sequences, and further causes the data processing system to:
responsive to receiving the input text, process the input text using natural language processing to identify one or more pieces of personally identifiable information;
perform a character analysis of each character of each piece of personally identifiable information of the one or more pieces of personally identifiable information to identify a character type of character in the piece of personally identifiable information;
for each piece of personally identifiable information and based on the associated identified character type, map the identified character type to an associated template character in a set of template characters in a template character data structure; and
utilizing the character-to-template mappings for the one or more pieces of personally identifiable information, generate an output text that projects the template characters by direct character-level mapping.

10. The computer program product of claim 9, wherein the computer readable program to perform the character analysis of each character of each piece of personally identifiable information of the one or more pieces of personally identifiable information to identify a character type of character in the piece of personally identifiable information further causes the data processing system to:
for each piece of the one or more pieces of personally identifiable information, generate a generic vector for the one or more characters of the piece.

11. The computer program product of claim 9, wherein the computer readable program to map the identified character type to the associated template character in the set of template characters in a template character data structure further causes the data processing system to:
for each piece of the one or more pieces of personally identifiable information, generate a template vector for the one or more template characters of the piece.

12. The computer program product of claim 9, wherein the computer readable program to generate the output text that projects the template characters by direct character-level mapping further causes the data processing system to:
for each piece of the one or more pieces of personally identifiable information, replace a generic vector with a template vector while maintaining the remainder of the input text as received.

13. The computer program product of claim 9, wherein the character type is selected from the group consisting of an uppercase character, a lowercase character, a number, an uncommon special character, or a common special character.

14. The computer program product of claim 9, wherein the set of template characters comprises a defined template character for each character type identified in the set of template characters.

15. An apparatus comprising:
at least one processor; and
at least one memory coupled to the at least one processor, wherein the at least one memory comprises instructions which, when executed by the at least one processor, cause the at least one processor to implement a personally identifiable information (PII) detection mechanism that facilitates privacy protection utilizing template embedding learned from text sequences, and further cause the at least one processor to:
responsive to receiving the input text, process the input text using natural language processing to identify one or more pieces of personally identifiable information;
perform a character analysis of each character of each piece of personally identifiable information of the one or more pieces of personally identifiable information to identify a character type of character in the piece of personally identifiable information;
for each piece of personally identifiable information and based on the associated identified character type, map the identified character type to an associated template character in a set of template characters in a template character data structure; and
utilizing the character-to-template mappings for the one or more pieces of personally identifiable information, generate an output text that projects the template characters by direct character-level mapping.

16. The apparatus of claim 15, wherein the instructions to perform the character analysis of each character of each piece of personally identifiable information of the one or more pieces of personally identifiable information to identify a character type of character in the piece of personally identifiable information further cause the at least one processor to:
for each piece of the one or more pieces of personally identifiable information, generate a generic vector for the one or more characters of the piece.

17. The apparatus of claim 15, wherein the instructions to map the identified character type to the associated template character in the set of template characters in a template character data structure further cause the at least one processor to:
for each piece of the one or more pieces of personally identifiable information, generate a template vector for the one or more template characters of the piece.

18. The apparatus of claim 15, wherein the instructions to generate the output text that projects the template characters by direct character-level mapping further cause the at least one processor to:
for each piece of the one or more pieces of personally identifiable information, replace a generic vector with a template vector while maintaining the remainder of the input text as received.

19. The apparatus of claim 15, wherein the character type is selected from the group consisting of an uppercase character, a lowercase character, a number, an uncommon special character, or a common special character.

20. The apparatus of claim 15, wherein the set of template characters comprises a defined template character for each character type identified in the set of template characters.
